(19) United States
(12) Patent Application Publication
(10) Pub. No.: US 2024/0067366 A1
(43) Pub. Date: Feb. 29, 2024

(54) GROUND TO SPACE LASER POWER DELIVERY METHOD AND SYSTEM

(71) Applicant: LUMI SPACE LIMITED, Yateley, Hampshire (GB)

(72) Inventor: Hira VIRDEE, Yateley, Hampshire (GB)

(21) Appl. No.: 18/266,014

(22) PCT Filed: Dec. 8, 2021
(86) PCT No.: PCT/GB2021/053212

§ 371 Date: Jun. 8, 2023

(30) Foreign Application Priority Data
Dec. 8, 2020 (GB) 2019266.2

(51) Int. Cl. B64G 1/42; B64G 3/00; B64U 50/31

(52) U.S. Cl. CPC B64G 1/428; B64G 3/00; B64U 50/31

(57) ABSTRACT

The present invention relates to a system for power delivery to satellites. More particularly, the present invention relates to a method and system for providing power to orbiting satellites from ground stations on Earth using laser light.

Aspects and/or embodiments seek to provide a method of delivering power to artificial satellites from ground stations using electromagnetic energy, for example laser light.

### FIELD

The present invention relates to a system for power delivery to satellites. More particularly, the present invention relates to a method and system for providing power to orbiting satellites from ground stations on Earth using laser light.

### BACKGROUND

The first Earth-orbiting artificial satellite was launched in 1957 and since then nearly 10,000 satellites have been launched into orbit around the Earth, of which it is estimated around 5,000 remain in orbit around the Earth. Many of the satellites remaining in orbit are no longer operational. These satellites fulfil, or fulfilled, a range of functions such as earth observation, communications, navigation, weather and as telescopes.

Initial artificial satellites were small and lightweight but, as launch technologies became more capable and reliable over time, the size of artificial satellites increased over time as the complexity and capabilities of such artificial satellites increased. Solar power has been used for artificial satellites since their inception. Artificial satellites designed to remain in orbit for significant periods of time have typically used a combination of solar panels and batteries to supply power to the on-board electronics needed to perform the functions of the satellite.

Solar panels used for artificial satellites are required to be reliable and capable of operating in challenging thermal and radiation environments. As a result, these demands mean that typically solar panels for use on artificial satellites are approximately a factor of 100 times more expensive that the equivalent terrestrial solar panels.

More recently, the size and payload of at least some artificial satellites has decreased significantly with the development of “cube” satellites and “nano” satellites—these are small artificial satellites having a standardised size, typically using standardised structures and some standardised components. Multiple of these “cube” and “nano” artificial satellites can, as a result, be launched at the same time using a single launch vehicle (often as a secondary payload). Use of this standardised sizing, standardised structures, and standardised components along with the ability to launch alongside a number of other artificial satellites in one launch vehicle (due to the relatively small dimensions of “cube” and “nano” artificial satellites compared to legacy payloads for which launch vehicles were designed) can significantly lower the cost of designing, building and launching artificial satellites. This has fueled a rapid growth in the industry and the number of active satellites is growing exponentially with publicly available information from relevant authorities (such as the FCC) indicating further growth will continue.

However, with the reduction in payload capacity of such artificial satellites due to the limitations of the small form factor, solar panel size is typically reduced thus significantly constraining the amount of energy input possible (and, though typically to a lesser extent, the amount of battery power that can be stored by the artificial satellite can be constrained). Due to this use of significantly smaller solar panels, a significant cost saving can be achieved. As a result, some artificial satellites must ration the amount that their electronics are used to preserve battery power and in order to operate using the constrained amount of power able to be generated with the solar panels provided on the artificial satellite (which may only provide sufficient power to enable the electronics to be used intermittently, for example). These design limitations have reduced the utility of some artificial satellites, in particular those satellites with for example high-power downlinks, or synthetic aperture radar imaging on-board, or other power-hungry payloads.

Further, as artificial satellites age, firstly the amount of charge that can be held by their in-built batteries decreases as the battery chemistry deteriorates and secondly the amount of power supplied by their solar panels decreases as the solar panels degrade or fail, or as electronics on board the satellite fails. At a certain level of degradation and component failure, artificial satellites can cease to perform their function usefully and become space debris that either remains in orbit or eventually exits orbit to burn up in the atmosphere or leave orbit into space.

As a result of limited solar panel size, battery degradation or component failure, when artificial satellites move into the section of their orbit where no sun light reaches their solar panels (which may, for example, around a third of their orbit), they can cease to operate for part, or all, of that section of their orbit as no new power is produced by their solar panels.

### SUMMARY OF INVENTION

Aspects and/or embodiments seek to provide a method of delivering power to artificial satellites from ground stations using electromagnetic energy, for example laser light.

According to a first aspect, there is provided an apparatus for providing power to an artificial satellite along an orbital trajectory, comprising: one or more lasers operable to generate a laser beam and at least one of the one or more lasers operable to perform laser ranging to determine the position of and/or distance to the artificial satellite from the at least one of the one or more lasers; at least one optical turbulence monitor operable to determine atmospheric conditions between at least one of the one or more lasers and the artificial satellite; at least one optical device operable to adjust the properties of the laser beam to compensate for determined atmospheric conditions between at least one of the one or more lasers and the artificial satellite and/or the determined position of and/or distance to the artificial satellite; and at least one tracking mount operable to substantially continuously direct the resulting laser beam towards the artificial satellite along a portion of the orbital trajectory, using the laser ranging determined position of and/or distance to the artificial satellite from the at least one of the one or more lasers.

Providing power to an artificial satellite using a laser coupled with adaptive optics and continuous tracking can enable enhanced functionality in the artificial satellite or can compensate for hardware failure or degradation in artificial satellites. Using laser ranging can allow precise positioning and/or assessment of distance to the satellite to be powered, and knowledge of the position and/or distance to the satellite to be powered can be used to track the satellite substantially accurately and/or can allow the properties of the laser beam(s) providing power to the satellite to be adjusted as required depending on the position of and/or distance to the satellite to be powered. Using an optical turbulence monitor can allow for substantially accurate measurement of the atmospheric turbulence between the laser(s) and the satellite to be powered and therefore can allow the modification of the laser beam(s) properties to adjust the laser beam(s) to compensate for the detected atmospheric turbulence. In alternative aspects, electromagnetic energy can be generated and transmitted to artificial satellites instead of a laser beam, for example microwave energy can be generated and transmitted).

Optionally, providing power to the artificial satellite comprises providing laser illumination to the photovoltaic panels of the artificial satellite.

Providing power using laser illumination of the photovoltaic panels of an artificial satellite can avoid needing to redesign artificial satellites to be able to use ground-based lasers to provide power to the artificial satellites.

Optionally, the orbital trajectory is a low earth orbit trajectory.

Artificial satellites in orbits that either don't have regular exposure to sunlight or which have different exposure to sunlight depending on the relative position of the sun and the Earth (or the relative position of the sun and the moon or the sun and Mars, in the alternative examples where the artificial satellite is orbiting the moon or Mars respectively rather than in a low earth orbit), such as some low earth orbits, can be particularly affected by a lack of sunlight to provide power using their photovoltaic panels and thus can gain significant advantage through power also being supplied from ground-based lasers.

Optionally, the one or more lasers comprises any or any combination of a fibre laser; a diode laser; a continuous wave laser.

Providing power from a ground-based laser that is a fibre laser and/or a diode laser and/or a continuous wave laser can allow for sufficient power to be generated from sufficiently compact hardware to generate a suitable laser beam to provide power to orbiting artificial satellites from a suitable ground station location.

Optionally, the one of more lasers comprises a plurality of lasers each operable to illuminate at least a portion of the artificial satellite.

By using a plurality of lasers to illuminate a single satellite, increased illumination of either a larger surface area of the artificial satellite or increased intensity of illumination of the artificial satellite can be possible.

Optionally, the laser beam comprises laser light having one or more wavelengths; optionally wherein the one or more wavelengths fall within the range between 500 nm and 1600 nm; optionally wherein the one or more wavelengths fall within the range between 850 nm and 1070 nm; further optionally wherein the one or more wavelengths comprises a wavelength of 1064 nm.

Using laser light to provide power to an orbiting satellite having wavelengths between 500 nm and 1600 nm, or more specifically between 850 nm and 1070 nm, or still more specifically at 1064 nm can allow for a substantial portion of the energy of the laser light to be transmitted through the atmosphere.

Optionally, the at least one optical device comprises a deformable mirror.

Using a deformable mirror as part of the adaptive optics of the system can allow for corrections to be made based on determined atmospheric conditions to minimise beam spread when the laser light reaches the artificial satellite.

Optionally, the determined atmospheric conditions are determined using any or any combination of: pulsed laser light; detecting back-scattering due to the presence of sodium atoms; detecting back-scattering due to the presence of molecules and/or particles; using a wavefront sensor; determining the visibility of a reference object, optionally a star; using multi-colour laser light; using integral field spectrographs.

A variety of techniques can be used to determine the atmospheric conditions between the laser and the artificial satellite to be powered using the laser light.

Optionally, the at least one optical device is mounted on the at least one tracking mount.

By mounting the optical device it can be used to provide adaptive optics on a tracking mount, the tracking mount can alight the optical device to direct the laser beam towards the artificial satellite to be powered.

Optionally, the tracking mount is operable to be controlled to track the artificial satellite using pre-determined trajectory data for the artificial satellite.

By using pre-determined orbital trajectory data, the relative position of the artificial satellite to the laser can be determined and the direction of the laser beam adjusted to point at the artificial satellite as it moves along the portion of its trajectory visible from the point on the Earth at which the laser is sited.

Optionally, there is further provided a beam expander operable to increase the diameter of the beam.

By using a beam expander, the system can expand the diameter of the laser beam in order to decrease the energy density of the beam to reduce the energy loss through heating of the atmosphere.

Optionally, there is further provided a collimator operable to adjust the properties of the laser beam to limit the spread of the laser beam.

By using a collimator, the properties of the laser beam can be substantially adjusted to control the beam spread at the targeted artificial satellite.

According to a second aspect, there is provided a method for providing power to an artificial satellite along an orbital trajectory, comprising: generating a laser beam using one or more lasers; performing laser ranging to determine the position of and/or distance to the artificial satellite from the at least one of the one or more lasers; using at least one optical turbulence monitor to determine atmospheric conditions between at least one of the one or more lasers and the artificial satellite; adjusting the properties of the laser beam and/or the determined position of and/or distance to the artificial satellite to compensate for determined atmospheric conditions between at least one of the one or more lasers and the artificial satellite using at least one optical device; and substantially continuously directing the resulting laser beam towards the artificial satellite along a portion of the orbital trajectory using at least one tracking mount, using the laser ranging determined position of and/or distance to the artificial satellite from the at least one of the one or more lasers.

According to a third aspect, there is provided a computer program product operable to perform a method for providing power to an artificial satellite along an orbital trajectory, comprising: generating a laser beam using one or more lasers; performing laser ranging to determine the position of and/or distance to the artificial satellite from the at least one of the one or more lasers; using at least one optical turbulence monitor to determine atmospheric conditions between at least one of the one or more lasers and the artificial satellite; adjusting the properties of the laser beam and/or the determined position of and/or distance to the artificial satellite to compensate for determined atmospheric conditions between at least one of the one or more lasers and the artificial satellite using at least one optical device; and substantially continuously directing the resulting laser beam towards the artificial satellite along a portion of the orbital trajectory using at least one tracking mount, using the laser ranging determined position of and/or distance to the artificial satellite from the at least one of the one or more lasers.

According to a fourth aspect, there is provided a system for providing power to an artificial satellite along an orbital trajectory, comprising: the artificial satellite; one or more lasers operable to generate a laser beam and at least one of the one or more lasers operable to perform laser ranging to determine the position of and/or distance to the artificial satellite from the at least one of the one or more lasers; at least one optical device operable to adjust the properties of the laser beam to compensate for determined atmospheric conditions between at least one of the one or more lasers and the artificial satellite and/or the determined position of and/or distance to the artificial satellite; and at least one tracking mount operable to substantially continuously direct the resulting laser beam towards the artificial satellite along a portion of the orbital trajectory, using the laser ranging determined position of and/or distance to the artificial satellite from the at least one of the one or more lasers.

### BRIEF DESCRIPTION OF DRAWINGS

Embodiments will now be described, by way of example only and with reference to the accompanying drawings having like-reference numerals, in which:

FIG. 1 shows an overview of a ground-to-space laser power distribution system of an example embodiment;

FIG. 2 shows an illustration of the use of multiple ground stations of the example embodiment;

FIG. 3 shows an example of where ground locations can be located on a map of the Earth according to the example embodiment;

FIG. 4 shows an illustration of the visibility of satellites from the example located ground stations indicated in FIG. 3;

FIG. 5 shows an example embodiment of the equipment used at a ground station;

FIG. 6 shows an example embodiment of a ground station laser and tracking system;

FIG. 7 illustrates the receiving of power at a satellite where there is a relatively large beam spread according to an embodiment;

FIG. 8 illustrates the receiving of power at a satellite where there is a relatively small beam spread according to an embodiment;

FIG. 9 shows an illustration of a multi-junction solar cell according to an embodiment;

FIG. 10 shows an illustration of the relative quantum efficiency of a silicon monocrystalline solar cell in response to light at a variety of wavelengths according to at least some embodiments;

FIG. 11 shows an illustration of the external quantum efficiency of a triple junction at a variety of wavelengths according to at least some embodiments; and

FIG. 12 shows an illustration of typical atmospheric absorption between 200 nm and 1200 nm according to at least some embodiments.

### SPECIFIC DESCRIPTION

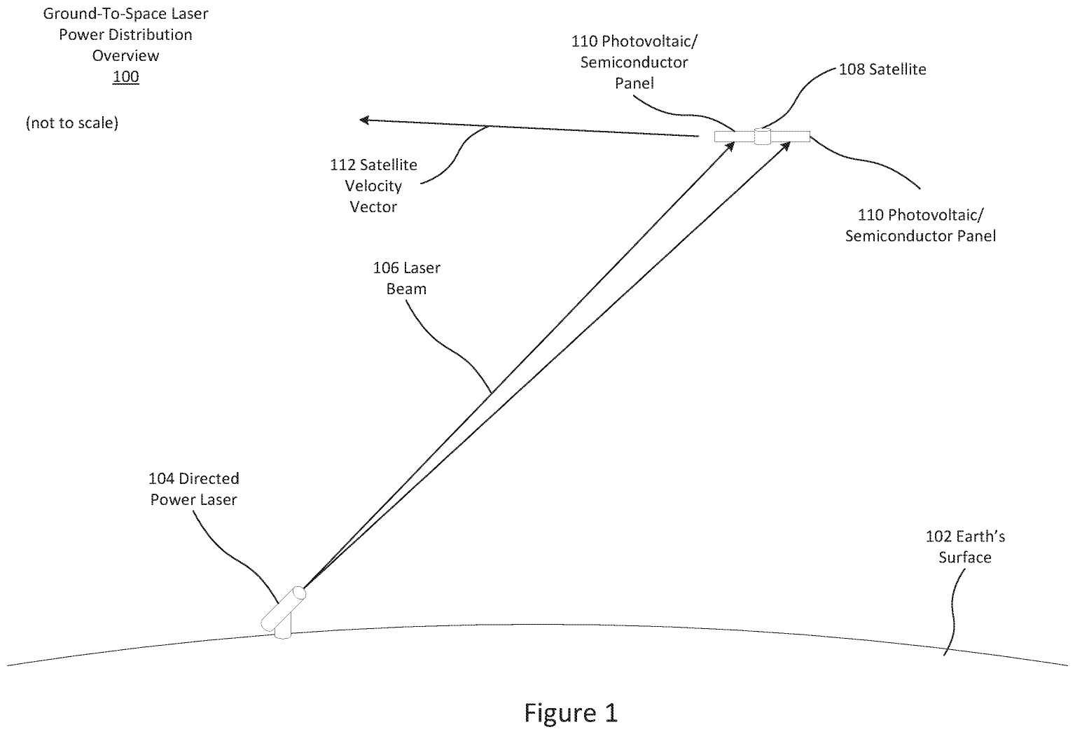

Referring to FIGS. 1 to 12, some example embodiments will now be described in detail.

Referring to FIG. 1, there is shown an overview of a ground-to-space laser power distribution system 100 of an example embodiment.

In the example embodiment one ground station is shown, having a directed power laser 104 located at a position on the earth's surface 102. In embodiments, multiple ground stations each having a directed power laser 104 can be used to provide increased coverage of satellite positions relative to the earth's surface 102. In some embodiments, the positions of the multiple ground stations allow an overlap in coverage so that power can be provided to an artificial satellite 108 seamlessly as it moves out of range of one ground station and into range of a neighbouring ground station.

In the example embodiment, the directed power laser 104 transmits power using a laser beam 106 to an artificial satellite 108 in orbit around the Earth which passes over the region of sky within range of the laser beam 106 along its velocity vector 112. The satellite 108 is tracked by the ground station, so that the directed power laser 104 can direct the laser beam 106 to target the photovoltaic/semiconductor panels 110 of the satellite 108. In other embodiments, multiple directed power lasers may be present at each ground station in order that multiple satellites can be powered simultaneously from a single ground station.

In the example embodiment, the light from the laser beam 106 reaches the photovoltaic/semiconductor panels (typically referred to as “solar panels”) 110 of the satellite 108, causing the panels 110 to absorb the light from the laser beam 106 and generate electricity which can then be used by the satellite to either or both charge its on-board battery and/or power its on-board electronics. Standard solar cells are used in the example embodiment, i.e. photovoltaic panels configured to convert sunlight into electrical power. In other embodiments, other types of photovoltaic or semiconductor panels may be used and in some embodiments these panels can be specifically adapted for, or operable to, generate electricity from the laser beam 106.

Embodiments of this system use lasers as a targeted, focussed means of sending energy to low-earth orbit (LEO) satellite solar panels from a network of stations on the ground. In some embodiments, a 6 kW fibre laser operating at a wavelength between 850 nm to 1070 nm is used.

This example embodiment should alleviate many problems faced by satellite operators, including for example (and not limited to) downlink during eclipse phase, night-time operations, and greater power availability to increase data rates.

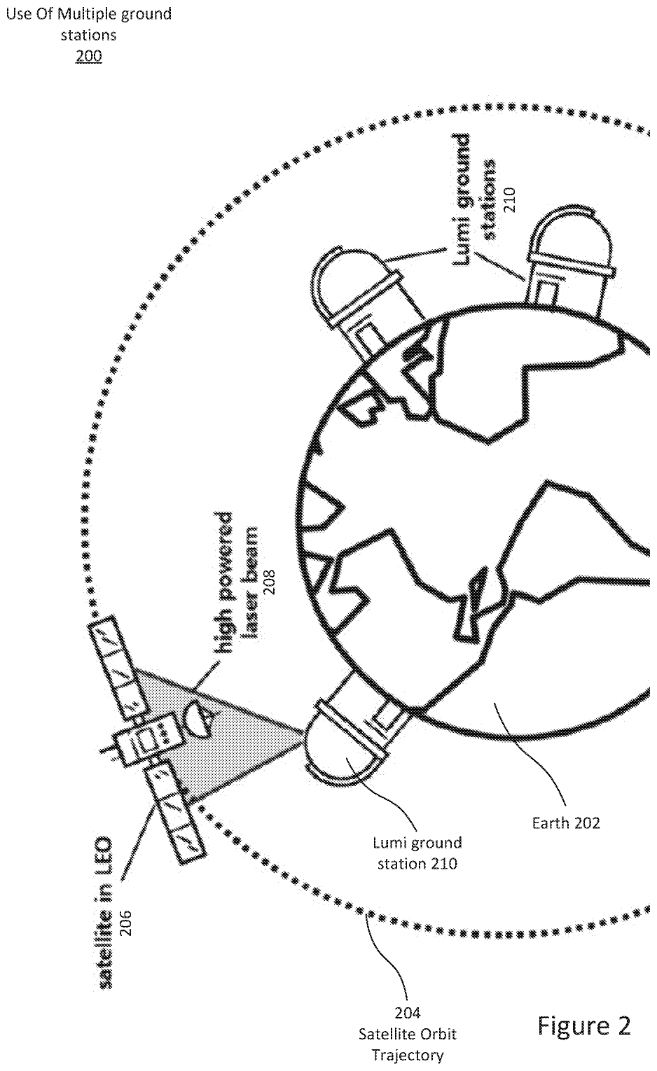

Referring to FIG. 2, there is shown an illustration 200 of the use of multiple ground stations of another example embodiment.

In this example embodiment, there are provided three ground stations 210 at various points on the Earth 202, such that a satellite in low-earth orbit (LEO) 206 orbiting along its satellite orbit trajectory 204 can be exposed to a high-powered laser beam 208 from each of the ground stations 210 as it passes over the respective ground station within range of the laser beam 208. As the satellite 206 passes within range of the laser beam 208 of each ground station 210, the power generated in the photovoltaic panels of the satellite 206 by the laser beam 208 can be used to power on-board electronics and/or charge the on-board battery by the satellite 206.

Use of multiple ground stations across different locations working as a network of ground-based lasers for power delivery to satellites provides redundancy and resilience to weather conditions as well as higher availability and coverage.

Using multiple systems at each ground location can increase the amount of power that can be delivered to each satellite, in some embodiments delivering up to 3× solar intensity of light to the solar panels of an artificial satellite.

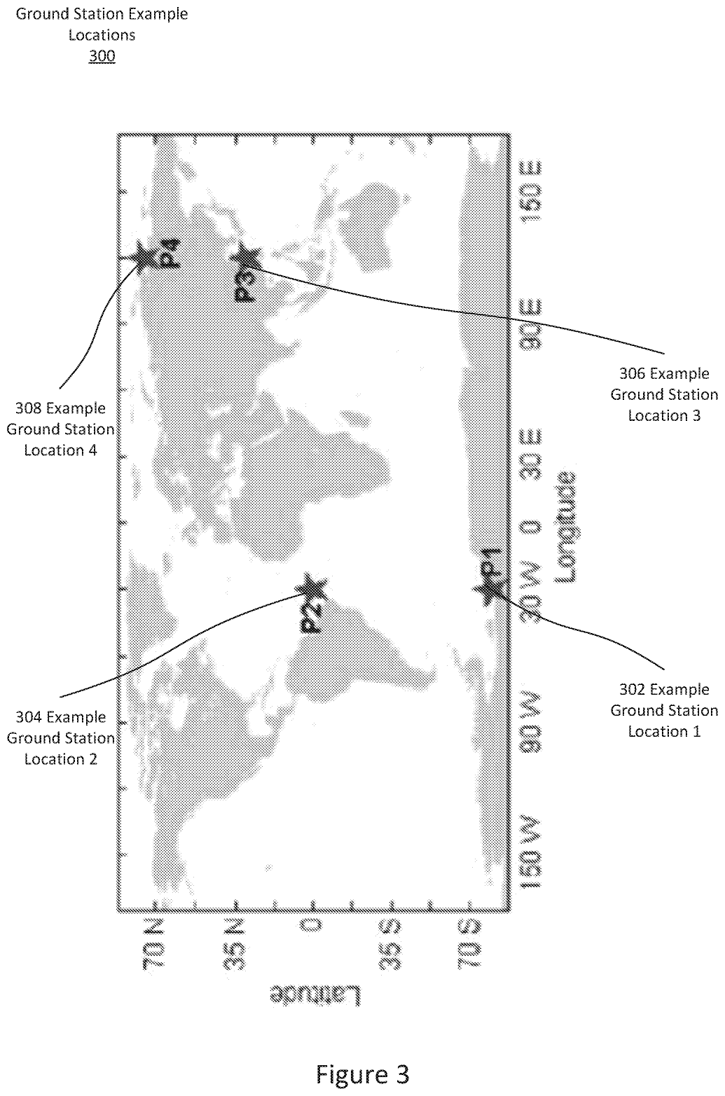

Referring to FIG. 3, there is shown an example of where ground locations can be located on a map of the Earth 300 according to another example embodiment.

In this example embodiment, four locations 302, 304, 306, 308 have been chosen on the Earth at different latitudes and longitudes and at each of these locations a ground station can be located in order to provide power via a laser beam directed at satellites orbiting overhead.

The choice of ground station locations will typically be dependent on environmental and orbital factors, including for example (but not limited to) any or any combination of: annual average cloud cover; visibility of satellite orbits; altitude (higher than 1 km above sea level means that the atmospheric effects are more favourable); the ability to target as many satellites as possible (based on, for example, the most common or most relevant orbits); minimising atmospheric effects to maximise system efficiency and effectiveness; and maximising system uptime. Higher and lower latitudes can provided a better view of satellite passes, and the use of large latitudinal differences of placement of ground stations, or positioning ground stations near the poles, can provide improved satellite visibility in at least some embodiments as, for example, most LEO satellites have a near-polar or sun-synchronous orbits thus pass over a relatively small area at the poles and therefore more such satellites would be visible from a ground station located at a near-polar location or at high or low latitudes.

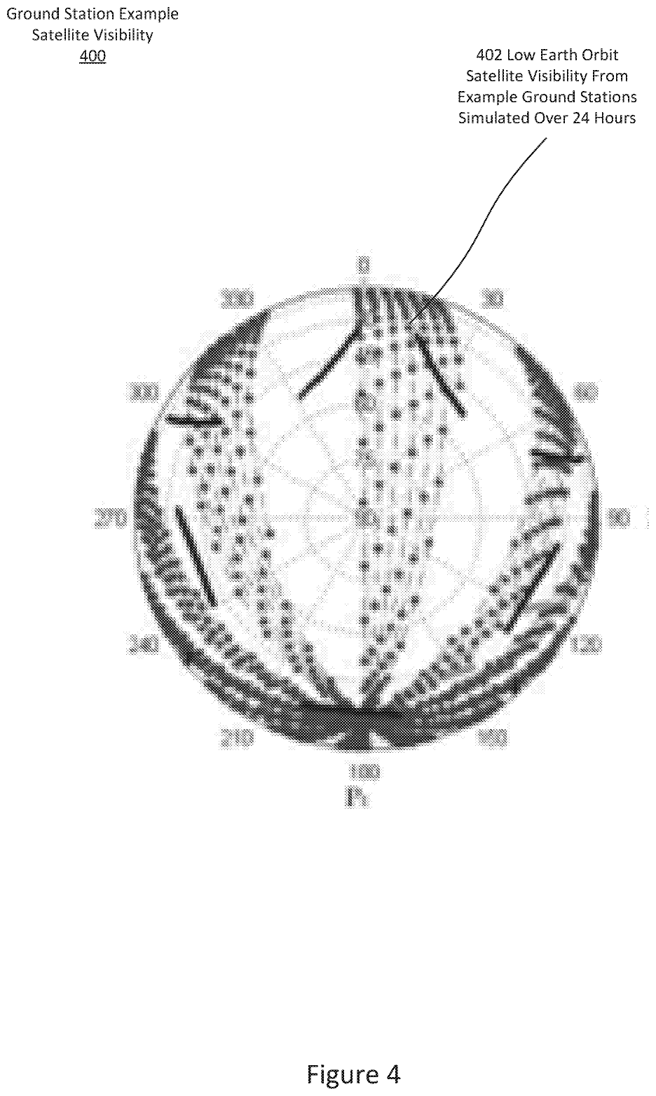

Referring to FIG. 4, there is shown an illustration of the visibility of satellites 400 from the example located ground stations indicated in FIG. 3.

For artificial satellites having LEO orbits that are polar, a near-pole ground station can observe the satellites at any revolution of polar orbits, thus to locate a position for ground stations to provide power to satellites having polar orbits one needs to select positions having latitudes that are close to polar regions in order to get visibility of as many polar orbiting satellites as possible.

In FIG. 4, it is shown how some example polar orbits around the Earth pass over both poles for an example 24-hour period and the point marked P1 indicates a pole of the Earth, showing that all of the orbits fly over this point and are visible from around the pole to a ground station located at a near-pole position on the Earth's surface.

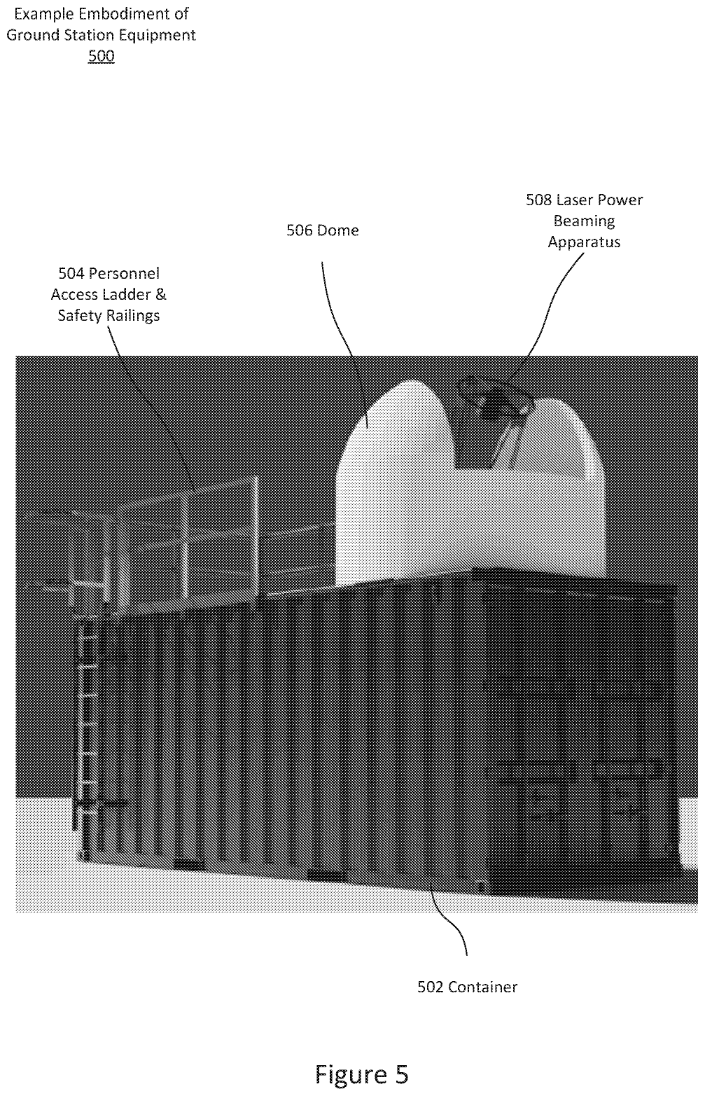

Referring to FIG. 5, there is shown an example embodiment of the equipment used at a ground station 500.

In this example embodiment, a self-contained ground station 500 will be described. The ground station 500 comprises a container 502 on top of which a dome 506 is mounted. Inside the dome 506, the laser power beaming apparatus 508 is mounted such that it can be positioned to point towards passing artificial satellites as they orbit the Earth. To access the dome 506 and laser 508, there is also provided a personnel access ladder and safety railings 504. Use of a container 502 allows for the ground station to be positioned temporarily, and moved if needed. Use of a container 502 also allows the majority of the construction of the ground station to be completed prior to installation of the equipment of the ground station at the location for the ground station, which could be in a remote and difficult to access location.

Three factors can affect the choice of what wavelength to use for the laser 508: atmospheric extinction (i.e. absorption, scattering, etc of the laser light in the atmosphere at each wavelength), solar panel efficiency and laser technology. A number of laser technologies exist, which output laser light across a variety of wavelengths. In this example embodiment, fibre lasers based on Nd:YAG (neodymium-doped yttrium aluminium garnet) diodes are used outputting light at 1064 nm wavelength, because Nd:YAG diode lasers can provide high power and are not cost prohibitive to output laser light at a 1064 nm wavelength.

As laser diodes typically provide poor beam quality, optical fibres are used in this example embodiment to improve beam quality. Fibre lasers are a relatively new laser technology, where laser diodes are passed through an optical fibre before being transmitted. Doing this allows much greater beam quality and also allows small adjustments to the wavelength (±10 nm), thus allowing small adjustments to the laser wavelength particularly tuned to causing the laser light to pass through the atmosphere in the area of each individual ground station. Fibre lasers have become smaller, more efficient, and more powerful due to their commercialisation in industrial cutting and welding—where a 5 kW laser used to be the size of a shipping container and costing more than £2 million, these are now available in units the size of a kitchen refrigerator costing around £50,000.

In other embodiments, different more permanent or more mobile arrangements may be used to construct a ground station, including more traditional brick, concrete, metal, and wood construction or by providing a ground station on a moveable platform.

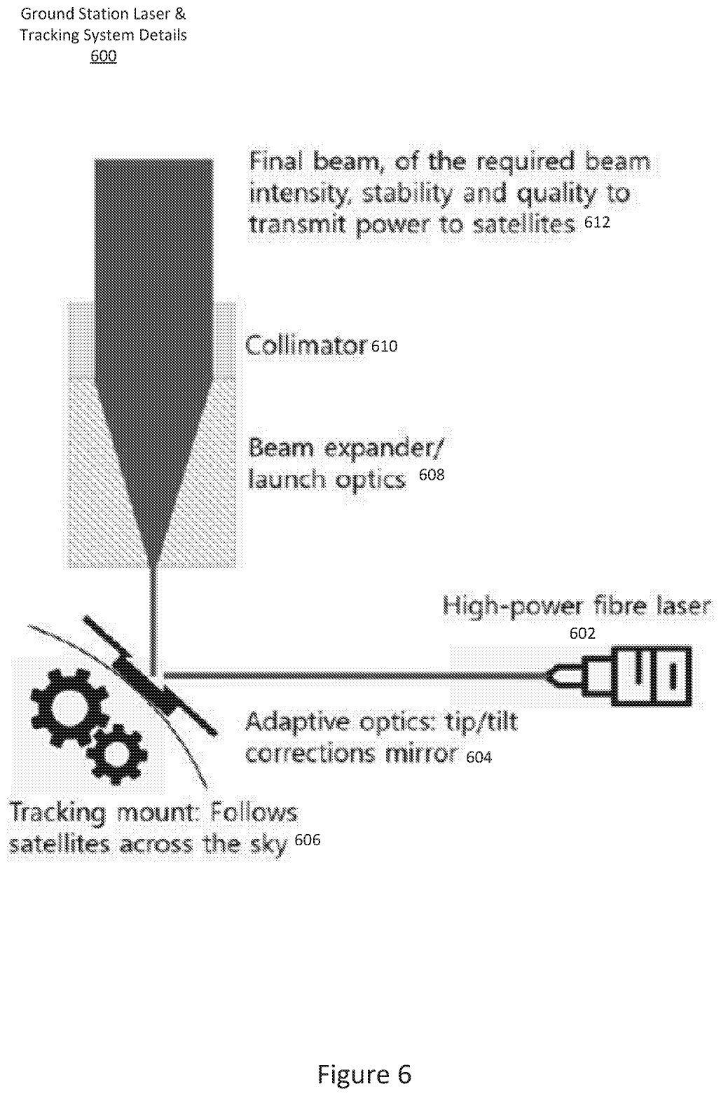

Referring to FIG. 6, there is shown an example embodiment of a ground station laser and tracking system 600.

With concerns about space debris growing, due to the exponentially increasing number of satellites in orbit, the knowledge of the contents of near-Earth space (including the space and position of both debris and active satellites) has significantly improved from metre-level accuracy to approximately <10 cm accuracy. Data sharing between governments and companies has opened up access to this data.

Through increasing application in the astrophysics and optical research communities, adaptive optics systems have become increasingly common with the prices dropping as a result. This allows their use as shown in the system shown in example embodiment 600.

In this example embodiment, a continuous wave high-power Nd:YAG-diode fibre laser 602 is used which outputs a laser beam having wavelength 1064 nm. The laser beam reaches the mirror of the adaptive optics 604. In other embodiments, a neodymium-doped glass (Nd:glass) laser or a ytterbium-doped glass (Yb:glass) laser or an Aluminium-Gallium-Arsenide (AlGaAs) diode laser or a Indium-Gallium-Arsenide-Phosphide (InGaAsP) diode laser may be used instead or in addition to the Nd:YAG fibre diode laser to produce one or multiple continuous wavelength outputs.

The adaptive optics system 604 comprises a deformable mirror mounted on a tracking mount 606 which can be tipped and/or tilted using actuators to deform the mirror, as well as the mirror orientation altered using the tracking mount, to make corrections to account for atmospheric conditions above the ground station and the movement of the artificial satellite as it passes over the ground station. The laser 602 thus remains stationary while the tracking mount 606 moves the deformable mirror and the adaptive optics 604 deforms the mirror to adapt for atmospheric conditions.

As light scatter distorts the wavefront of the laser, which increases the divergence of the beam and clauses deflections, depending on the speed of the beam deflection in some embodiments this can be adjusted for mechanically or by using a tip/tilt mirror array to change the deflection of the beam.

In an example embodiment, the adaptive optics 604 uses a so-called “laser guide star” approach to determining the atmospheric conditions above the ground station—this technique uses a pulsed beam of laser light focussed at one or more points firstly at an altitude of about 90 km and then at an altitude of about 10 km which causes back-scattering of by sodium atoms in the high mesosphere and then molecules and particles in the low stratosphere. A wavefront sensor measuring the scattered laser light is used to correct for the wavefront aberrations caused by the atmosphere. In other embodiments, other techniques used to assess the atmospheric conditions above the ground station can include the use of a reference star and/or the use of multicolour laser light and/or the use of integral field spectrographs or similar equipment to perform multi-conjugate adaptive optics.

The tracking mount 606 is operable to allow the laser beam to track the position of the satellite as it moves along its orbital path above the ground station, ensuring that the laser beam constantly illuminates the satellite solar panels as it moves across the sky above the ground station.

Tracking data can be received from satellite tracking databases to determine the position at which to direct the laser beam using the tracking mount 606. In other embodiments, satellite laser ranging can be used and/or a telescope system can be used to pinpoint the relative position and velocity of an artificial satellite to which power is to be provided (this may require retroreflectors to be fitted to the satellite to increase accuracy of tracking).

The beam reflects from the deformable mirror of the adaptive optics 604 and passes through a sequence of optics, including a beam expander 608 and a collimator 610 to produce the final beam 612.

The beam expander 608 creates the launch optics by taking the collimated beam of light reflected from the adaptive optics 604 and expand its size. As beam divergence for a gaussian beam decreases as the width of the beam increases, the use of the beam expanded 608 will reduce the beam divergence. Having a wider beam also reduces thermal blooming (i.e. heating of the air by the laser) as the power is spread over a wider beam area.

The collimator 610 creates the final beam 612 by shaping the output beam and ensuring that the output beam is aligned in the direction of the artificial satellite being targeted such that it has an intensity, stability, and quality to transmit power to the artificial satellite.

In embodiments, to provide a safety control of the system, a narrow beam radar having a <5-degree conical beam is mounted adjacent to the laser beam expander 608 and collimator 610 to detect if any objects have entered the airspace between the laser and the artificial satellite, i.e. into the path of the laser beam. Should the radar detect an unexpected aerial object it triggers a shutoff mechanism until it is determined that the object has moved out of the path of the laser beam at which point laser power transmission can recommence. In other embodiments, a human spotter can activate a beam shutoff switch or air traffic data/a broad field radar can be used to automatically shut off the laser when air traffic is predicted to pass within the path of the laser beam.

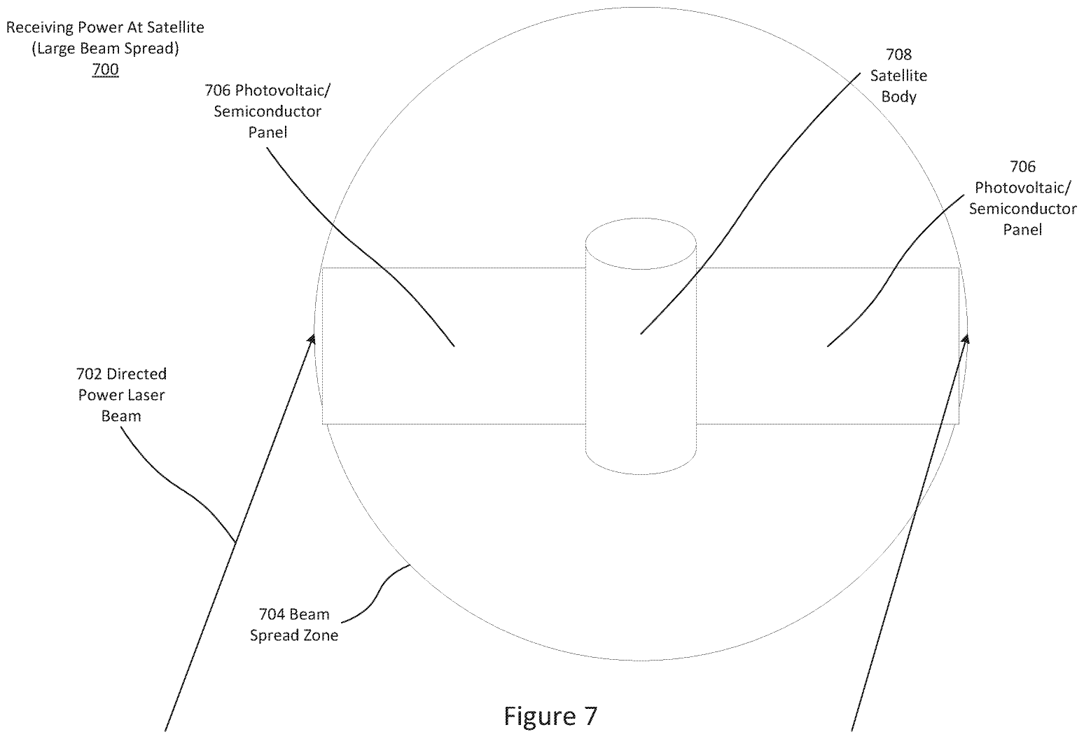

Referring to FIG. 7, there is shown an illustration 700 of the receiving of power at a satellite where there is a relatively large beam spread 704 according to an embodiment.

With a 3-metre diameter spot in orbit, i.e. a 3-metre diameter laser beam by the time the laser light reaches the artificial satellite at its orbit height about the Earth, it the example embodiment >1% of the laser power can be transmitted to an example 3U “cube” satellite (i.e. 15% of power can be received at a 30% efficiency). In this example embodiment, a 2-10 kW laser is used at the ground station to ensure that sufficient power is transmitted to be useful to the artificial satellite. With adaptive optics, transmission should be 90% efficient through the atmosphere, however re-targeting and downtime (e.g. due to weather conditions) can account for approximately a 50% loss. At typical costs for terrestrial power versus the cost of power using solar panels suitable for artificial satellites, this level of efficiency would mean that power using terrestrial lasers provided to satellites would be cheaper.

Depending on the beam spread 704 at the point at which the beam 702 illuminates the satellite 708 and its photovoltaic panels 706, and the size of the satellite 708 and its panels 706, it is possible that the beam spread will cause all of the satellite 708 and panels 706 to be illuminated. This ensures that substantially all of the surface area of the panels 706 are illuminated but also means that the satellite body 708 is illuminated and the region around the satellite 708 and panels 706 are illuminated.

In some embodiments, a 50 cm diameter, 1064 nm wavelength laser beam with a power of 2 kW produced by a fibre laser is expected to provide a beam of the order of approximately 500 cm radius at a range of 500 km with a resulting collection efficiency at an artificial satellite of around 30%, assuming a pointing stability of around Sprad. In other embodiments, improved performance in terms of collection efficiency is achieved by siting the ground station at a high-altitude site (at a height above sea level of around 3000 m) having favourable atmospheric conditions, increasing the collection efficiency to around 90%.

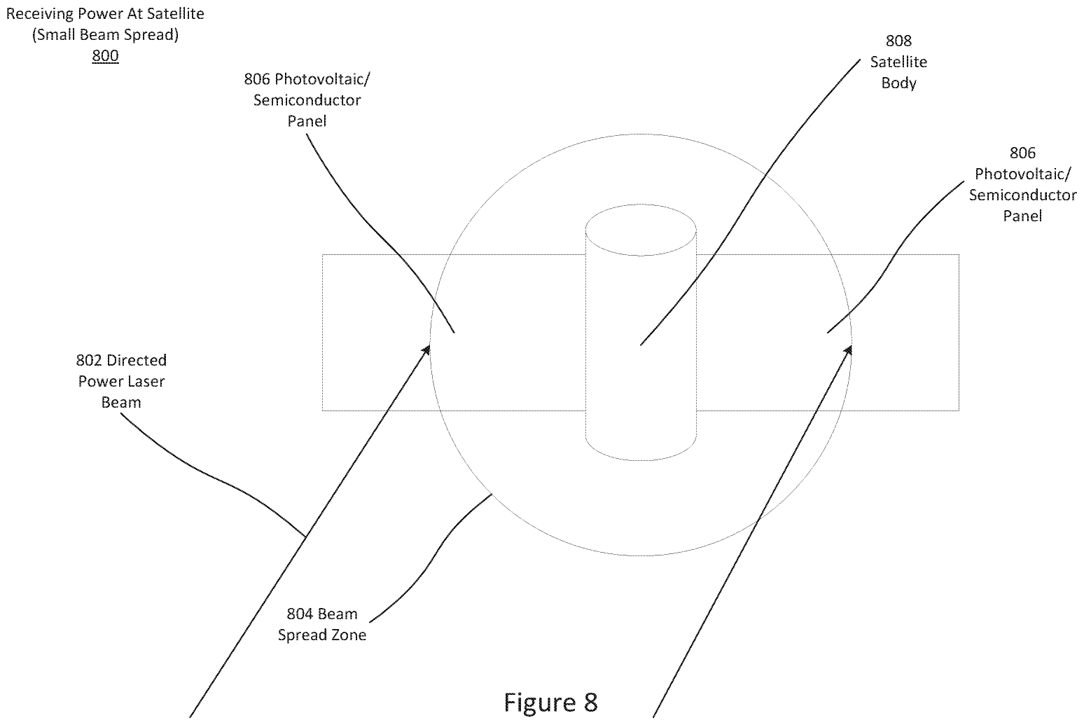

Referring to FIG. 8, there is shown an illustration 800 of the receiving of power at a satellite where there is a relatively small beam spread according to an embodiment.

To achieve a 3-metre diameter spot in orbit, at a distance of 600 km between ground station and artificial satellite, the laser needs to have very low beam divergence.

Where a larger satellite is illuminated, this can mean that the beam spread 804 does not illuminate the entire surface area of the panels 806 of the satellite 808—for example if the satellite 808 is larger than the satellite 708 shown in FIG. 7. In this example, the use of multiple beams 802 can allow for all of the area of the panels 806 to be illuminated.

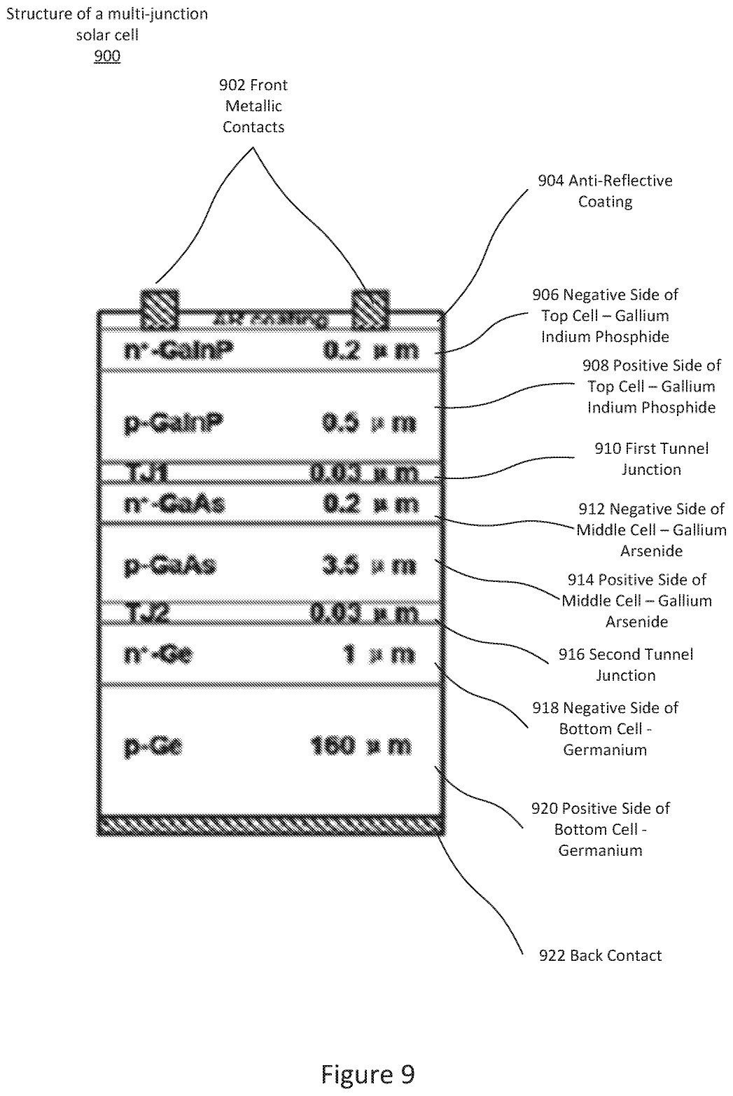

Referring to FIG. 9, there is shown an illustration of a multi-junction solar cell 900 according to an embodiment.

The two main technologies for space grade solar panels are silicon-based solar cells and triple junction solar cells.

The basic requirement for efficient solar panel operation is that the material constituting the cells forming the panels is strongly absorbing across the solar spectrum. The majority of solar panels are photovoltaics and directly convert incoming solar photons into electron-hole pairs which in turn generate a voltage and allow current to flow from the cells. The main challenges associated with converting the energy from photos into electrical energy is due to three main factors: (1) the need to achieve high absorption across the full spectral range; (2) the need for low series resistance to minimise parasitic voltage drops and improve the fill factor of the solar panel (the fill factor being the maximum fraction of the current-voltage product that can be usefully delivered as power), which is most prominent under high illumination; and (3) the need for high shunt resistance to avoid current and voltage drops from the solar cell, both of which reduce the fill factor, and which is most prominent under low illumination.

To overcome the fundamental problem of limited absorption bandwidth, multi-junction solar cells such as the example cell 900 were developed. In multi-junction solar cells, different absorbing layers are used to absorb different parts of the solar spectrum. Each layer is configured to account for the absorption coefficient variation across the spectral region of use and the solar spectrum—the thickness of each layer is therefore used to ensure that the current generation rate in each layer is equal. Tunnel junctions, consisting of wide band gap semiconductors, are used to provide a low optical loss layer for transferring carriers through the structure.

To provide power efficiently using a laser to both silicon-based solar cells and triple-junction solar cells, wavelengths between 500 nm and 1100 nm are preferable and accordingly embodiments provide power at one or more wavelengths between 500 nm and 1100 nm.

This embodiment shows the structure of an example multi-junction solar cell 900, comprising a layered structure comprising: two front metallic contacts 902 embedded in an anti-reflective coating layer 904; then a top cell; a first tunnel junction 910; a middle cell; a second tunnel junction 916; a bottom cell; and a back contact 922. The top cell comprises a negative side 906 and a positive side 906, both made of GaInP (Gallium Indium Phosphide). The middle cell comprises a negative side 912 and a positive side 914, both made of GaAs (Gallium Arsenide). The bottom cell comprises a negative side 918 and a positive side 920, both made of Ge (Germanium).

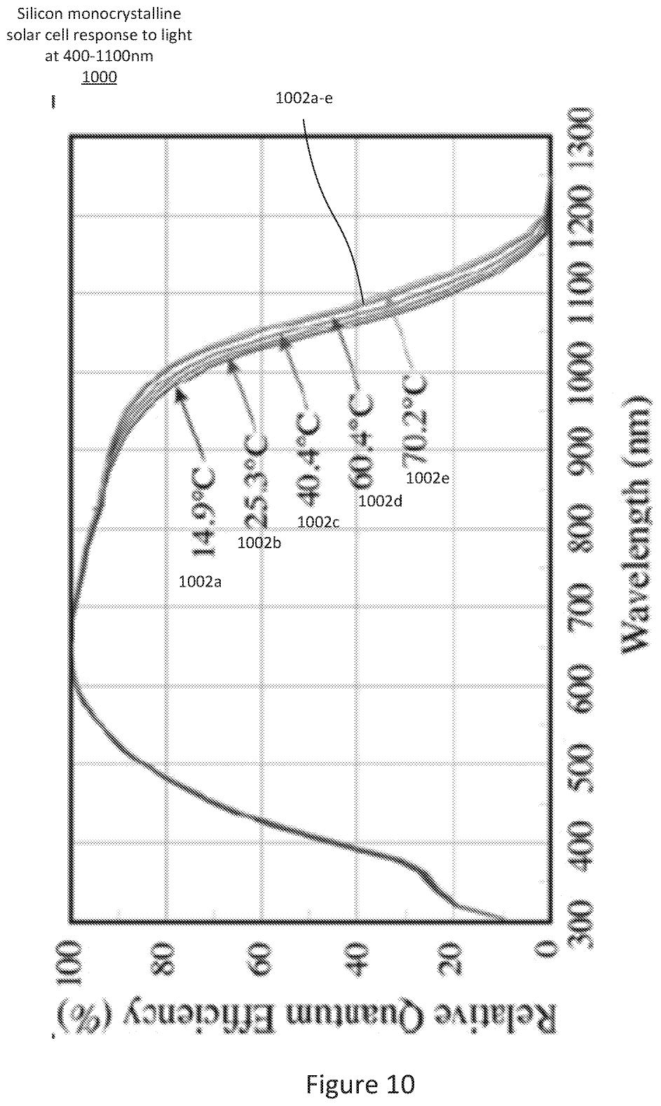

Referring to FIG. 10, there is shown an illustration 1000 of the relative quantum efficiency of a silicon monocrystalline solar cell in response to light at a variety of wavelengths according to at least some embodiments.

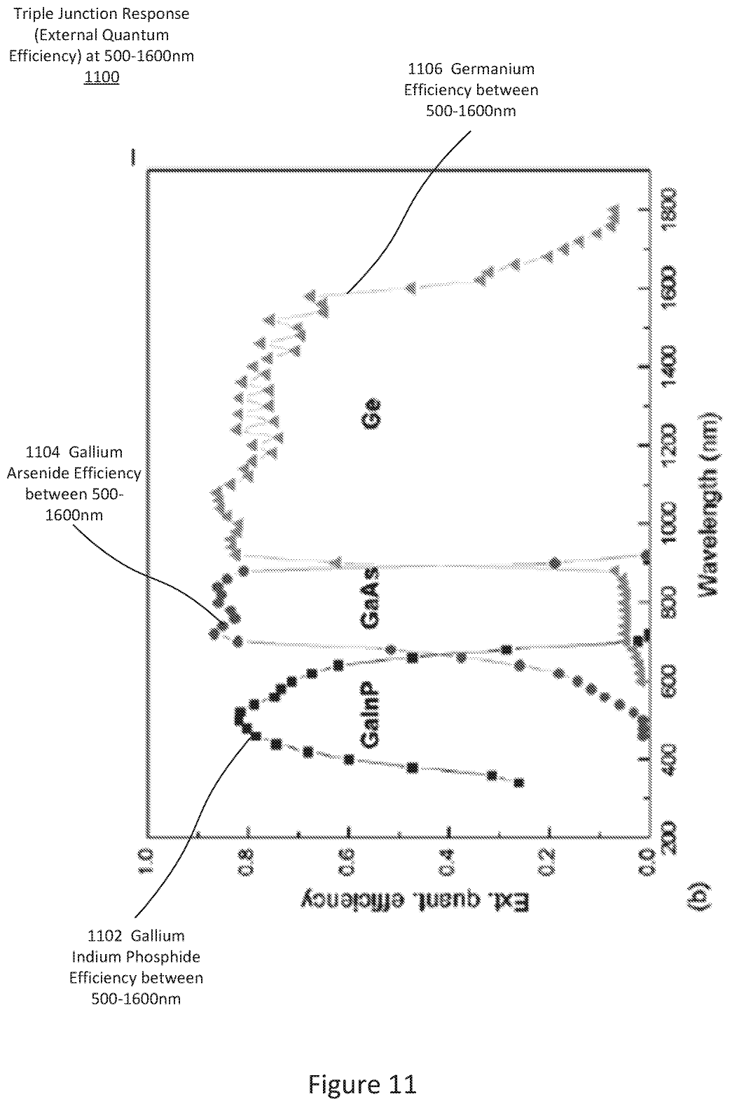

The response to light having wavelengths between 400 nm and 1100 nm of a silicon monocrystalline solar cell indicates that light having a wavelength between approximately 500 nm and 1000 nm has a >80% relative quantum efficiency, thus would be a range within which laser light would cause sufficient power to be generated when illuminating the solar cell. Referring to FIG. 11, there is shown an illustration 1100 of the external quantum efficiency of a triple junction at a variety of wavelengths according to at least some embodiments.

The response of the different layers of the multi-junction cell shown in FIG. 9 can be seen in the graph of external quantum efficiency over the wavelengths of light illuminating the panel. The top cell response 1102 shows a response between wavelengths of approximately 300 nm and 700 nm with peak response around 500 nm. The middle cell response 1104 shows a response between wavelengths of approximately 500 nm and 900 nm which peak response around 700 nm to 900 nm. The bottom cell response 1106 shows a response between wavelengths of approximately 600 nm and 1800 nm with peak response between around 900 nm and 1600 nm. Thus across the range of approximately 500 nm to 1600 nm a relatively strong response will be present in a multi-junction panel when illuminated with light, but while sunlight will illuminate the panel across a plurality of these wavelengths, one or more lasers will typically only illuminate the panel with one wavelength of light (or a handful of wavelengths of light if multiple lasers are used, each at different wavelengths).

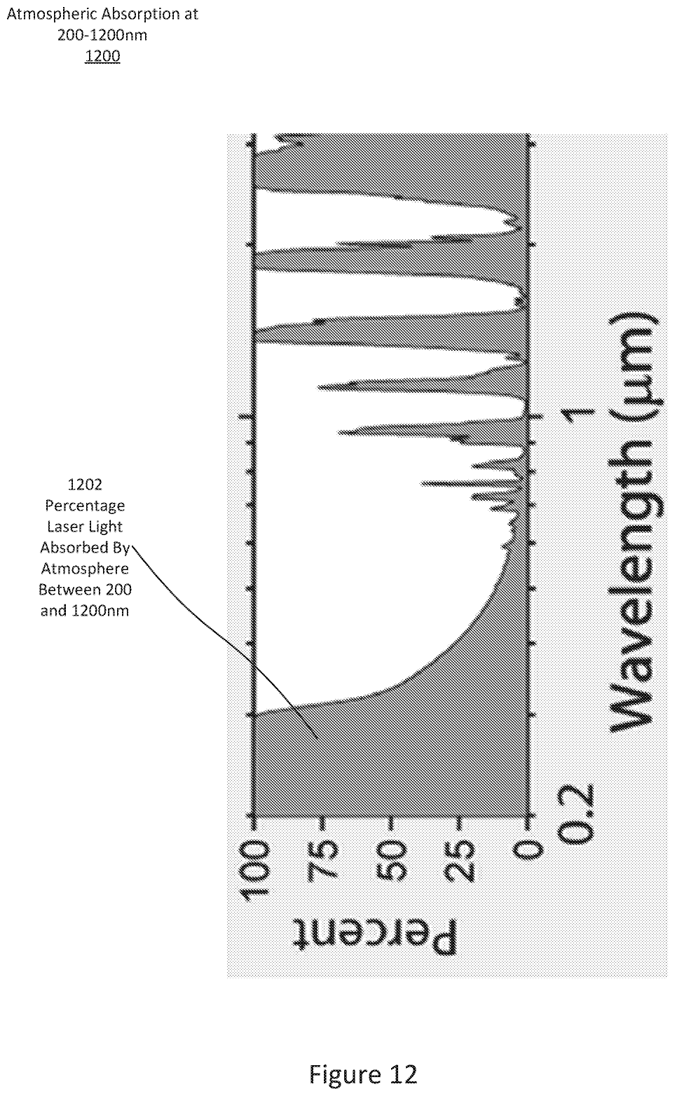

Referring to FIG. 12, there is shown an illustration of typical atmospheric absorption between 200 nm and 1200 nm according to at least some embodiments.

Atmospheric scattering and absorption are higher for the lower end of the range between 200 nm and 1200 nm as shown in FIG. 12, causing atmospheric extinction (i.e. causing laser light to be absorbed completely by the atmosphere and/or scattered by the atmosphere such that no laser light would reach an artificial satellite). It will be seen, however, there are particular wavelengths between 500 nm and 900 nm, and at approximately 1000 nm, 1300 nm, 1700 nm and 2100 nm where extinction is very low and thus which wavelengths are suitable candidates for use to transmit power to artificial satellites using laser light.

In some embodiments, to ensure an efficient link between the ground station and satellite, laser ranging is used. Laser pulses are reflected from the satellite and their return trip time enables high precision positioning (for example the distance to and/or position of the satellite relative to the laser(s)). This enables precise positioning of the satellite within its orbit and accurate targeting of the satellite as a result, enabling the tracking mount to accurately direct the laser beam(s) at the satellite. In embodiments where the orbit is known, then the positioning can be correlated with the orbit to increase the precision of the satellite positioning.

In some embodiments, in order to correct for atmospheric turbulence, an optical atmospheric turbulence monitor is used. The optical atmospheric turbulence monitor determines atmospheric turbulence between the laser(s) and the satellite, and the determined turbulence can be used to modify the properties of the laser beam (for example beam width and/or wavelength and/or focus) in order to compensate for the atmospheric turbulence and substantially optimise power delivery to the satellite.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. Apparatus for providing power to an artificial satellite along an orbital trajectory, comprising:
one or more lasers operable to generate a laser beam and at least one of the one or more lasers operable to perform laser ranging to determine the position of and/or distance to the artificial satellite from the at least one of the one or more lasers;
at least one optical turbulence monitor operable to determine atmospheric conditions between at least one of the one or more lasers and the artificial satellite;
at least one optical device operable to adjust the properties of the laser beam to compensate for determined atmospheric conditions between at least one of the one or more lasers and the artificial satellite and/or the determined position of and/or distance to the artificial satellite; and
at least one tracking mount operable to substantially continuously direct the resulting laser beam towards the artificial satellite along a portion of the orbital trajectory, using the laser ranging determined position of and/or distance to the artificial satellite from the at least one of the one or more lasers.

2. The apparatus of claim 1, wherein providing power to the artificial satellite comprises providing laser illumination to the photovoltaic panels of the artificial satellite.

3. The apparatus of claim 1, wherein the orbital trajectory is a low earth orbit trajectory.

4. The apparatus of claim 1, wherein the one or more lasers comprises any or any combination of: a fibre laser; a diode laser; a continuous wave laser.

5. The apparatus of claim 4, wherein the one of more lasers comprises a plurality of lasers each operable to illuminate at least a portion of the artificial satellite.

6. The apparatus of claim 1, wherein the laser beam comprises laser light having one or more wavelengths; optionally wherein the one or more wavelengths fall within the range between 500 nm and 1600 nm; optionally wherein the one or more wavelengths fall within the range between 850 nm and 1070 nm; further optionally wherein the one or more wavelengths comprises a wavelength of 1064 nm.

7. The apparatus of claim 1, wherein the at least one optical device comprises a deformable mirror.

8. The apparatus of claim 1, wherein the determined atmospheric conditions are determined using any or any combination of: pulsed laser light; detecting back-scattering due to the presence of sodium atoms; detecting back-scatting due to the presence of molecules and/or particles; using a wavefront sensor; determining the visibility of a reference object, optionally a star; using multi-colour laser light; using integral field spectrographs.

9. The apparatus of claim 7, wherein the at least one optical device is mounted on the at least one tracking mount.

10. The apparatus of claim 9, wherein the tracking mount is operable to be controlled to track the artificial satellite using pre-determined trajectory data for the artificial satellite.

11. The apparatus of claim 1, further comprising a beam expander operable to increase the diameter of the beam.

12. The apparatus of claim 1, collimator operable to adjust the properties of the laser beam to limit the spread of the laser beam.

13. A method for providing power to an artificial satellite along an orbital trajectory, comprising:
generating a laser beam using one or more lasers;
performing laser ranging to determine the position of and/or distance to the artificial satellite from the at least one of the one or more lasers;
using at least one optical turbulence monitor to determine atmospheric conditions between at least one of the one or more lasers and the artificial satellite;
adjusting the properties of the laser beam and/or the determined position of and/or distance to the artificial satellite to compensate for determined atmospheric conditions between at least one of the one or more lasers and the artificial satellite using at least one optical device; and
substantially continuously directing the resulting laser beam towards the artificial satellite along a portion of the orbital trajectory using at least one tracking mount, using the laser ranging determined position of and/or distance to the artificial satellite from the at least one of the one or more lasers.

14. A computer program product operable to perform the method of claim 13.

15. A system for providing power to an artificial satellite along an orbital trajectory, comprising:
the artificial satellite;
one or more lasers operable to generate a laser beam and at least one of the one or more lasers operable to perform laser ranging to determine the position of and/or distance to the artificial satellite from the at least one of the one or more lasers;
at least one optical device operable to adjust the properties of the laser beam to compensate for determined atmospheric conditions between at least one of the one or more lasers and the artificial satellite and/or the determined position of and/or distance to the artificial satellite; and
at least one tracking mount operable to substantially continuously direct the resulting laser beam towards the artificial satellite along a portion of the orbital trajectory, using the laser ranging determined position of and/or distance to the artificial satellite from the at least one of the one or more lasers.
